(19) United States
(12) Patent Application Publication
(10) Pub. No.: US 2005/0228859 A1
(43) Pub. Date: Oct. 13, 2005

(54) Content data reproduction program

(76) Inventor: Yukitoshi Maeda, Nara (JP)

Correspondence Address: PITNEY HARDIN LLP, 7 TIMES SQUARE, NEW YORK, NY, 10036-7311, US

(21) Appl. No.: 10/363,730

(22) PCT Filed: Jul. 25, 2002
(86) PCT No.: PCT/JP02/07565

§ 371 Date: Mar. 6, 2003

(30) Foreign Application Priority Data
Dec. 21, 2001 (JP) 2001-389265

(51) Int. Cl. G06F 15/16; G06F 15/167

(52) U.S. Cl. 709/203; 709/217; 709/213

(57) ABSTRACT

The present apparatus offers a file data playback program that can restrict playback with certainty, without barring the communication of information to users, even if it is used for playback of files that are frequently played back and stopped repeatedly. This is the file data playback program for operating a computer as the playback means and playback stop means of file data. Playback is started from the position which the playback start position pointer 53 indicates. The apparatus has the processing which stops a playback and the processing which updates the playback start position pointer 53 in a playback stop position. The playback start position pointer 53 is updated.

### FIELD OF THE INVENTION

The present invention relates to playing back of files for which payment is required, and which often carry out stop processes at the moment of playback, and further relates to file data playback programs that can place restrictions on the condition of playback.

### BACKGROUND OF THE INVENTION

Recently a lot of systems that play back various file data with computers or the Internet have been used. Generally, these playback systems can play back repeatedly when necessary, and providers of files set their prices accordingly. However, in some cases, file users want to get files at cheaper prices even if the number of times of playback, for example, is limited. In these cases, a playback system that limits the number of times of playback etc. is necessary.

For example, in the official bulletin on Japanese Patent Publication No. 2000-347696, the playback apparatus is disclosed after definition of one time of playback is given.

In the official bulletin on Japanese Patent Publication No. 2001-290709, the method of providing file data that transfers playback conditions such as playback permitted periods, repeating times of playback etc., and controls playback based those provisions.

### DISCLOSURE OF THE INVENTION

However, it is difficult to apply the apparatus of the prior art to the cases that frequently stop playback of the files, like educational ones, during playback.

That is, although in the apparatus disclosed in the official bulletin on Japanese Patent Publication No. 2000-347696, which aims at music data etc. stored in memory cards, playback can be done repeatedly unless it corresponds to the definition of one time of playback, it cannot be completely restricted in the case of above-mentioned files because in this case to define on time of playback itself is difficult.

Moreover, the apparatus disclosed in the official bulletin on Japanese Patent Publication No. 2001-290709 discloses only measurement of repeating times of playback and restriction of playback by a comparison with transferred playback condition, without disclosure of process in the case that playback is stopped before completion.

The present invention has been made in consideration of the above. The present invention relates to a file data playback program, a file data distribution server etc. The file data playback program can certainly restrict playback without disturbing the information communicated to the audience.

An aspect of the present invention is a file data playback program in order to function computers as means to play back file data and a means to stop playing them back; wherein the means to play back file data are means to start playback from the position indicated by a playback start position pointer, and the means to stop playing back file data are means to carry out a step of stopping playback, and a step of renewing said playback start position pointer at the playback stop position, wherein said playback start position pointer is renewed with said means to stop playing back file data.

According to this file data playback program, when the user pushes the playback or similar button, means to play back file data starts playback of file data from the position indicated by a playback start position pointer. Then, when the user pushes the stop or similar button, means to stop playing them back stops playback and sets the playback start position pointer at the playback stop position.

When playback is subsequently imitated, as means to play back restarts playback from the position that the playback start position pointer which is previously set indicates, playback can be continued from the position where it was stopped previously.

Therefore, the file data playback program can play back files continually even if playback and stop are carried out repeatedly. However, files played back once are not played back again because the playback start position pointer is set at the position where playback stopped by means to stop playback. Hence, if it is used for playback of files for which payment is required that are frequently played back and stopped repeatedly, it becomes possible to restrict playback without damaging the files.

In another aspect of the present invention, playback start position pointer is renewed not only by means to stop playback but also a means to control the pointer.

Although a means to control the pointer returns position information to the part which has already been played back when it is desirable to play back files by pushing the rewind button, for example, such a function is stopped after the prescribed playback condition is fulfilled.

Therefore, the file data playback program can play back files continually even if playback and stop are carried out repeatedly on one hand, and it can control the once played-back part is played back repeatedly under prescribed conditions. Therefore, if it is used to play the file which permits the repetition of playback of a small number of times, it becomes possible to control the playback conditions.

A still further aspect of the present invention relates to the file data playback program of the previous aspects wherein after ending a playback, it has a means to delete the played back file data. According to this file data playback program, it becomes possible to control playback with certainty because this program can delete the played back file data.

A still further aspect of the present invention relates to the file data playback program described in previous aspects wherein the playback stop means has the processing to delete the played back file data. According to this file data playback program, it becomes possible to control playback with certainty because the deletion of the played back file data which ended the playback is performed when playback stops.

A still further aspect of the present invention is the storage medium with which said programs were stored, and can start a computer in the way described above by communicating with a computer and loading the program.

A still further aspect of the present invention is the server wherein it is possible to distribute said program to a user terminal via a communication network, and it also becomes possible to distribute this program to many users easily.

A still further aspect of the present invention is the file data distribution system which comprises the program distribution server described above, the file distribution server and user terminal. This system makes it possible to distribute the file data which has playback restrictions immediately and easily via a communication network.

A still further aspect of the present invention can distribute the file data which has a playback restriction on real time using what is called streaming distribution. Moreover it becomes possible to control playback with certainty by managing distribution with a server.

In a still further aspect of the present invention, it is possible to play back the file which permits the small repetition of playback with restriction with certainty, even if in the case of streaming distribution.

Note that the term “file data” in this invention corresponds to digital information and data, such as characters, voices, and images, and computer programs. It includes digital music, movies, and novels, and also includes software games. In addition, the term playback corresponds to the following: (1) outputting music sounds to the speakers of user terminals designed for digital music, (2) showing movies on the displays of user terminals designed for digital movies, (3) showing novels on the displays designed for digital novels, (4) making software games available on the user terminals designed for software games.

Besides, contents suitable for this invention is information which has value even if it is played back one time or a small number of times. For example, educational information, a movie, live recordings, etc.

### BRIEF DESCRIPTION OF THE DRAWINGS

FIG. 1 is a block diagram showing the general structure of the file distribution system of one aspect of the present invention.

FIG. 2 is a block diagram showing the general structure of the file distribution server of one aspect of the present invention.

FIG. 3 is a flow chart to demonstrate the registration process at the user-registering module for one aspect of the present invention.

FIG. 4 is a diagram to illustrate the divide-and-spread process of the digital file data for one aspect of the present invention.

FIG. 5 is a flow chart to illustrate the distribution process at the transferring module for one aspect of the present invention.

FIG. 6 is a flow chart to show the playback process for one aspect of the present invention.

FIG. 7 is a flow chart to illustrate the distribution process at the transferring module for one aspect of the present invention.

FIG. 8 is a block diagram showing the general structure of the file playback program for one aspect of the present invention.

FIG. 9 is a block diagram showing the general structure of the file data distribution server one aspect of the present invention.

### DETAILED DESCRIPTION OF THE PREFERRED EMBODIMENT

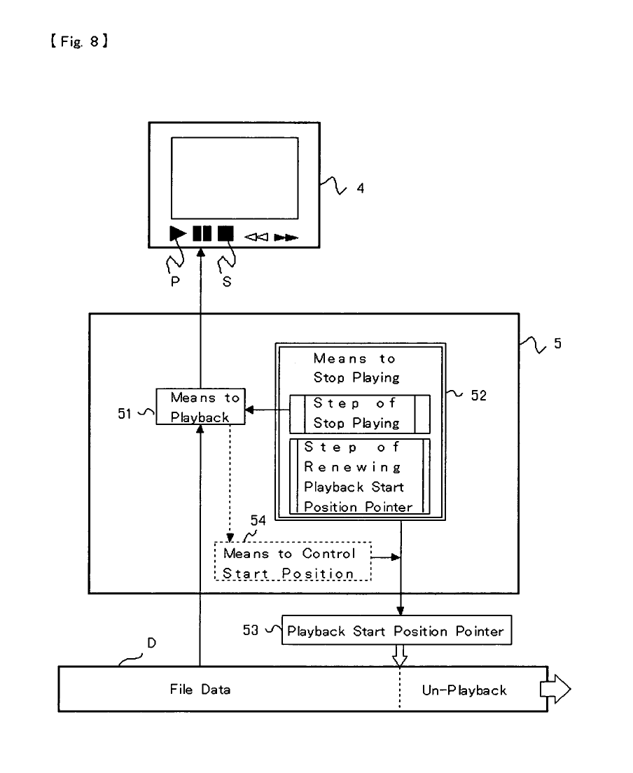

Details of one way of implementation for the present invention will be described below using the attached figures. FIG. 8 is a block diagram showing the general structure of the file playback program for the way of its implementation.

As shown in FIG. 8 the file playback program 5 of this particular aspect operates a computer as the playback means 51 and a playback stop means 52, inputs file data D, and plays a file back to the CRT display of user-terminal equipment 4 etc.

The playback means 51 plays file data back by pushing the playback button P from the position indicated by the playback start position pointer 53. Although a specific playback step differs according to the kind of target file data, it includes the case where various outputs of which an image and voice are output and also appeals to the senses, the case where it outputs interactively, performing the input from a user.

Moreover, it is desirable that the playback start position pointer 53 is updated by only the playback stop means 52 because if the playback start position pointer 53 is easily updated by other means, it will become possible to play back freely by each user, and control of playback is not attained.

The playback stop means 52 stops playing back by pushing stop button S and performs processing which updates said playback start position pointer 53 in the playback stop position other than the processing which carries out a playback stop.

If an example of this processing is explained, after playback stop instruction is input and it performs playback stop processing first, it is processing which updates the contents of the playback stop position pointer to the present playback position information, and is processing which performs stop processing, after updating the contents of the playback start position pointer 53 to the present playback position information.

Moreover, the playback start position pointer 53 being updated by the playback stop means 52 only is desirable. If the playback start position pointer 53 is easily updated by other means, it will become possible to play back freely by each user, and the purpose of this invention to control playback is not attained.

However, after fulfilling the prescribed playback conditions, it is desirable to change the numerical value of a playback start position pointer by establishing the pointer control means 54 which suspends the updating function of the playback position pointer 53 after fulfilling the prescribed playback conditions. That is, if it is the pointer control means 54, playback control of rewinding is possible until it satisfies the prescribed playback conditions, on the other hand, after fulfilling prescribed conditions, free playback processing can be made impossible and playback control can be carried out.

In addition, the prescribed playback conditions are the prescribed number of times of a playback, playback time, a period, etc.:

In the case of the number of times of playback, it determines whether the prescribed playback conditions are satisfied with carrying out the increment of the counter, whenever it performs playback processing to the last of a file of prescribed playback conditions.

In the case of playback time, it determines whether the prescribed playback conditions are satisfied with carrying forward a timer during playback and timing the additional time.

In the case of a prescribed period, it determines whether the prescribed playback conditions are satisfied by comparing the prescribed time to a built-in clock.

The updating function of a pointer control means 54 to suspend the function after fulfilling prescribed playback conditions is the so-called rewinding processing which returns the position of a pointer to the part which already ended playback.

Furthermore, this file data playback program 5 may have a means to delete the file data which ended the playback. That is, when it determines prescribed playback conditions were satisfied like the above, it performs processing which deletes the file data of the part which already completed playback. Thereby, after satisfying prescribed playback conditions, it can control the file data not to be played back again with certainty.

It may have means to delete this file data by carrying out one process of the playback stop means 52. In this case, the playback stop means 52 performs processing which deletes the file data of the part which already ended the playback, after performing a process which carries out a playback stop.

The above-mentioned file data playback program may be distributed using recording media, such as a floppy disk or CD-ROM, or via a communication network.

As a latter example, the case that a file data playback program and file data are distributed using the Internet is explained.

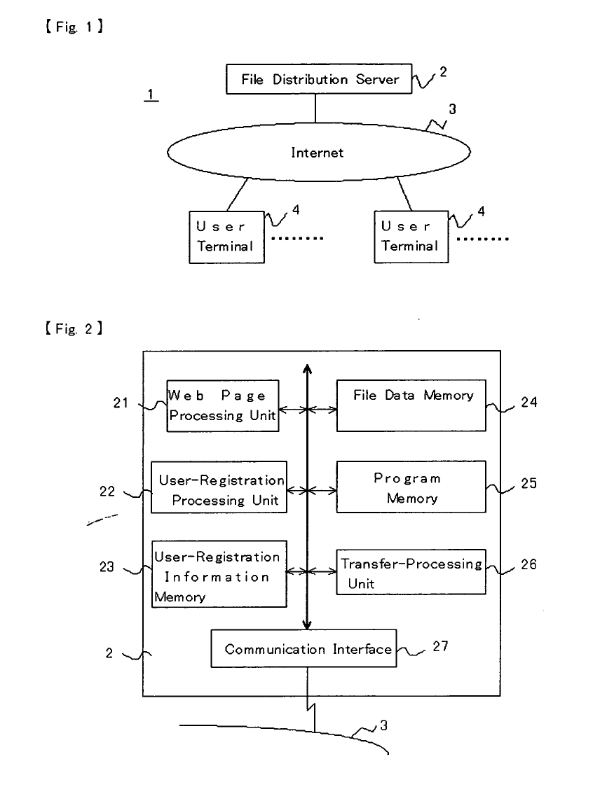

FIG. 1 is a block diagram showing the outline composition of this distribution system, and FIG. 2 is a block diagram showing the outline composition of the server for distribution used by this system.

As shown in FIG. 1, the file distribution system 1 of this particular way of implementation is composed of a distribution server 2 and multiple user terminals 4, all of which are connected via the internet 3 etc. The distribution server 2 functions as a server with CGI script and the internet servers such as WWW servers. Each of the user terminals 4 functions as a client with browsers.

The distribution server 2 is a computer with a CPU, ROM, RAM, and hard discs. As shown in FIG. 2, it has some function components such as a web page processing unit 21, a user-registration processing unit 22, a user-registration information memory 23, a contents data memory 24, a program memory 25, a transfer-processing unit 26, and a communication interface 27. The server is connected to the Internet 3 with the communication interface 27.

The web page processing unit 21 is a processing unit which opens up home pages on the Internet 3 for file distribution. Through these home pages, several processes are carried out such as user registration, transfer of the above mentioned file playback program, and distribution of digital files.

The user-registration processing unit 22 registers system-user information inputted from the user terminals 4 with the home pages. In detail, as shown in FIG. 3, when a user's registration information such as name, address, credit card number, e-mail address, password, etc, is input through the user terminal 4 (step S1), the user-registration processing unit 22 receives the information (step S2). Then the unit assigns an ID number to the user, and transfers it to the user terminal 4 (step S3). Each of the received user information and the assigned ID number is then stored in the user-registration information memory 23 (step S4). The screen of the user terminal 4 displays the transferred ID number (step S5) so that the user can see the number and subsequently write it down if desired.

The contents data memory 24 stores various digital file data such as information data including characters, voices, and images (novels, essays, music, movies, pictures, paintings, designs, etc), and computer programs (software games).

The program memory 25 stores the file data playback program, such as the management program of transferring of data and a cipher key, which are transferred to the user terminal 4, and are run or used in the terminal.

The transfer-processing unit 26 transfers the file playback program etc., which are stored in the program memory 25, in response to the request from the user terminal 4. The unit also loads requested digital file data from the file data memory 24, and it transfers them to the user terminal 4.

Distribution of the program concerned is simply attained instantly to many users by such a file distribution system.

Furthermore, use of file information can be controlled still more certainly by distributing the control program explained below in addition to a file data playback program.

That is, said management program is started on the user terminal 4 and carries out the following six processes; (1) making the storage space in the memory of user terminal 4 for digital file data to be transferred from the transfer-processing unit 26; (2) storing the transferred digital file data and deletion condition data into the storage space made in the previous process, after converting them into divided-and-spread data group according to a rule set in advance; (3) re-storing the converted file data to original digital file data, by re-converting the converted data stored in the memory according to the setting rule; (4) decrypting the restored digital file data; (5) playing back the decrypted digital file data on the user terminal 4; and (6) checking if the deletion conditions are fulfilled, and if they are fulfilled, the program deletes the converted file data stored in the memory.

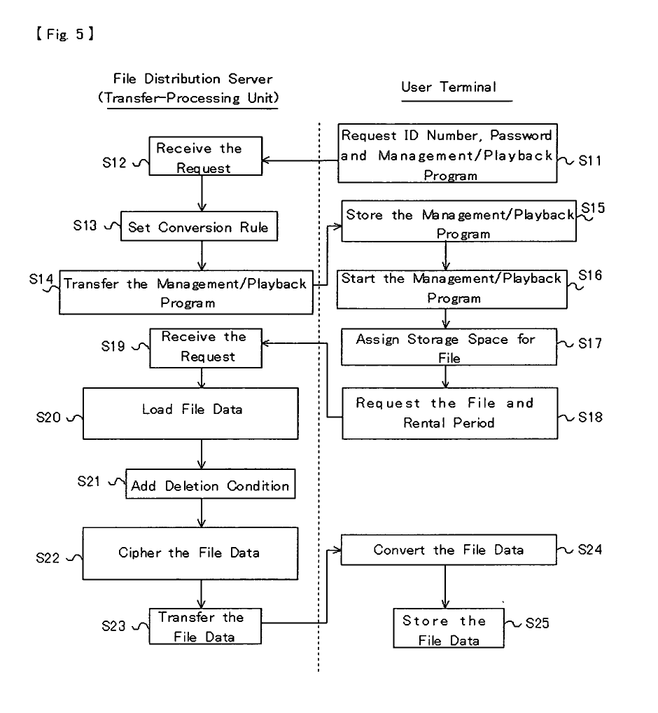

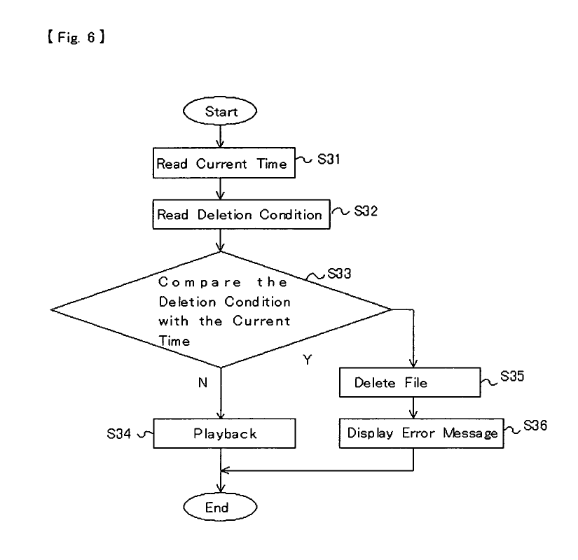

More details of the transfer-processing unit 26 and the management program process will be explained below, using FIG. 5 and FIG. 6.

First, the distribution process of the files is described based on FIG. 5. As shown in FIG. 5, when a user terminal 4 inputs a request for transfer of user information such as an ID number and a password or that of a management program via web pages (step S11), the transfer-processing unit 26 receives the request (step S12). Then, the transfer-processing unit 26 loads the requested management program and a cipher key from the program memory 25, and sets a conversion rule for the divide-and-spread process of the digital contents. The conversion rule is unique to each one of its users' files (step S13). The set conversion rule data is transferred together with the management program and the cipher key to the requesting user terminal 4 (step S14), and then they are stored in the user terminal 4 (step S15).

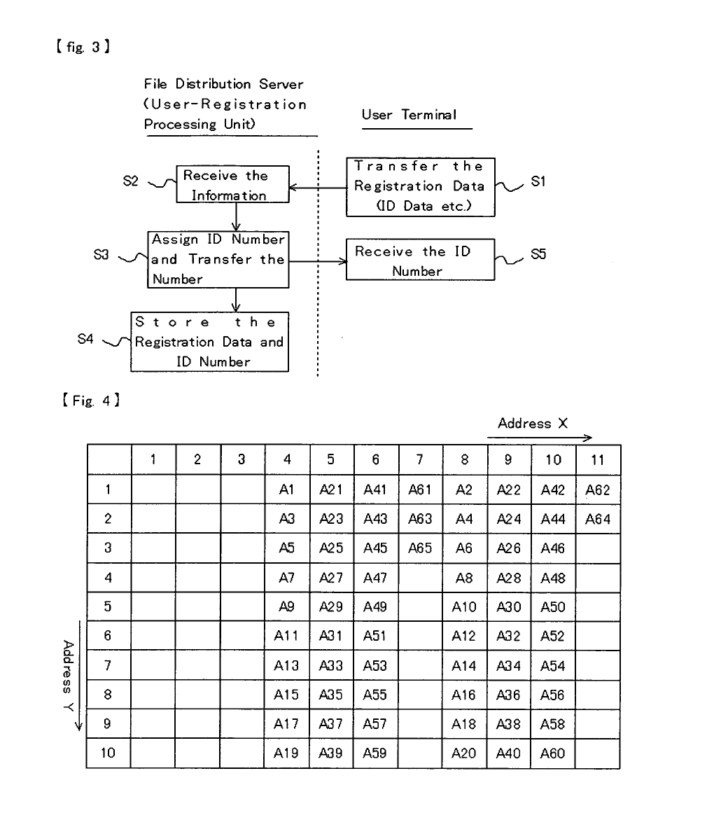

Next, when the transferred management program is started on the user terminal 4 (step S16), this management program makes storage space in the memory of the user terminal 4 for storing digital file data to be transferred from the file distribution server 2 (step S17). Specifically, as shown schematically in FIG. 4, the program sets two-dimensional storage space with addresses in vertical (Y) and horizontal (X) dimensions. The size of the storage space is adjusted according to the amount of data to be stored in the space.

After the setting of the storage space, the management program enables the user terminal 4 to request a file from the file distribution server 2 (step S18). In other words, the program opens communication between the file distribution server 2 and the user terminal 4, and displays a file list, which is stored in the file data memory 24 of the file distribution server 2, on the screen of the user terminal 4. Then, the program makes it possible for user to select desired files from the displayed list, or to enter the playback conditions.

Then, after the necessary information of the playback conditions is fixed on the user terminal 4 (step S18), it is transferred to the file distribution server 2, and received by the transfer-processing unit 26 (step S19).

By receiving the input from the user terminal 4, the transfer-processing unit 26 loads requested digital file data from the file data memory 24 (step S20). Then, the transfer-processing unit 26 adds the deletion condition to the loaded digital file data (step S21), and after encrypting the data, transfers them to the user terminal 4 (step S23). Now, considering the playback process that will be done later, the deletion condition is desirable to be a fixed-size data and to be inserted in the head of the digital file data. Thus, the present invention adopted this procedure.

After receiving the encrypted digital file data and the deletion condition that is added to it, the management program run on the user terminal 4 converts the received data into the divided-and-spread data group according to the conversion rule (file data conversion, step S24). Then, the program stores the data into the storage space so as to make the data discontinuous partly or completely (step S25).

The specific way of the divide-and-spread process is as the following. First, the received data is sequentially divided into segments with predetermined size. Then, the divided data is stored in the memory with the address calculated by the formula,
X=P×α+β
where P is constant assigned for and unique to each user, α is an integer that has the value form 1 to n, and β is an integer with the value from 0 to m. Also, n depends on horizontal size of the storage space, and m depends on P. In this case, the conversion rule is the formula, and the term “conversion to divided-and-spread data group” corresponds to the action of storing the digital file data into the storage space after dividing and spreading.

More specifically, the management program sets the address of Y=1 and the value of β=0, and then it changes α sequentially from 1 to n. Using these values, the program calculated address X with the formula shown above, and stores divided data in the storage space corresponding to the calculated address (X, Y=1). Afterwards, changing the address Y from 2 to a fixed maximum value, and setting β=0 and changing α from 1 to n, the program calculates address X by changing β from 1 to m sequentially and iterating the same process. And then the program stores divided data sequentially in the derived address (X, Y).

FIG. 4 shows the way of storing the divided file data (A1-A65) in the address calculated above, by setting the maximum value of address X=11, that of address Y=10, P=4, α=1 to 2, and β=0 to 3. The divided file data is not stored in the space of address X=1 to 3.

In this way, the term “partly discontinuous” is defined as the state in which there are other data between the divided file data stored in X-directionally, if the direction of data reading is X-direction. Similarly, the term “completely discontinuous” is defined as the state in which other data are stored in all the spaces between each of the reading-directionally divided file data. The term “other data” in above definitions corresponds to other file data or any data other than file data. Regarding the case shown above, the divided file data would be completely discontinuous if β is set taking only odd or even numbers. In this way, digital file data and deletion condition data attached to it is distributed from the file distribution server 2 to the user terminal 4, and then the data is stored in the user terminal.

The process of playing back the digital file that is stored in the user terminal 4 is described below, based on FIG. 6.

When the management program is started on the user terminal 4, and selected to play back the digital file stored in the memory, the playback process in the file data playback program is carried out. As shown in FIG. 6, the program reads current time from a clock function in the user terminal 4 (step S31), and then it loads the deletion condition stored in the memory (step S32).

The deletion condition data is inserted at the head of digital file data, and stored in the memory together with the file data after it is divided and spread. Therefore, the process of loading the deletion condition data starts with calculating the address X, Y in which the deletion condition data is stored. The address is calculated according to the conversion rule (the above formula). Then the data is decrypted with the cipher key, which is transferred from the server 2 together with management program and stored in the user terminal 4.

Next, current time and the deletion condition data are compared (step S33). If the deletion condition is not satisfied, the selected digital files are played back (step S34). On the contrary, if the deletion condition is satisfied, the digital file data stored in the memory are deleted (step S35).

The playback includes three processes: (1) loading of the digital file data that is stored in the memory after dividing and spreading, (2) decrypting of the loaded digital file, (3) playing back of the deciphered digital file data. These processes can be carried out either in serial/parallel, or entirely in serial.

The loading process of the digital file data is done in the same way as the loading process of deletion condition data. That is, the addresses X and Y are calculated sequentially according to the conversion rule (the above formula), and the data stored in the address are loaded sequentially. This loading process is denoted as a re-converting process. The decrypting process is done similarly based upon the cipher key, which is transferred with the management program and stored in the user terminal 4. The playback process (step S34) ceases when the playback of the contents is completed.

The deletion process (step S35) is a process to overwrite a part or all of the digital file data with other data. The address X, Y of the digital file data is determined using the conversion rule (the above formula). After this process, the management program shows error messages on the screen of the user terminal 4, and the messages notify users that the contents were deleted (step S36). By this display of the error messages, the series of the deletion processes is completed.

As described above, in the file distribution system 1 in this case, the requested digital file data are divided according to the rules (conversion rule) set uniquely for each user, and then stored in the user terminal 4 discontinuously spread. In addition, without the management program that has a re-conversion function of digital files based on the rules uniquely set for each user, the distributed file cannot be played back. Therefore, even if transferred digital files (converted digital files) are copied, general playback programs cannot play back the copied files. In addition, because each management program does not have compatibility with each other, users cannot play back digital file data that are distributed to other users. Furthermore, by converting file data into divided-and-spread data group, analyzing and restoring the data become highly difficult.

Hence, by using the file distribution system 1 of this case, pirating of the transferred files becomes meaningless, and this fact makes it possible to prevent illegal usage of transferred files and piracy by illegal copying and the distribution of it.

In addition, the only management program that is necessary to play back the files also carries out the deleting process of the distributed digital file. Therefore, when users run the program in an attempt to play back the digital file that is outside of the rental period, the program reliably deletes the invalid file.

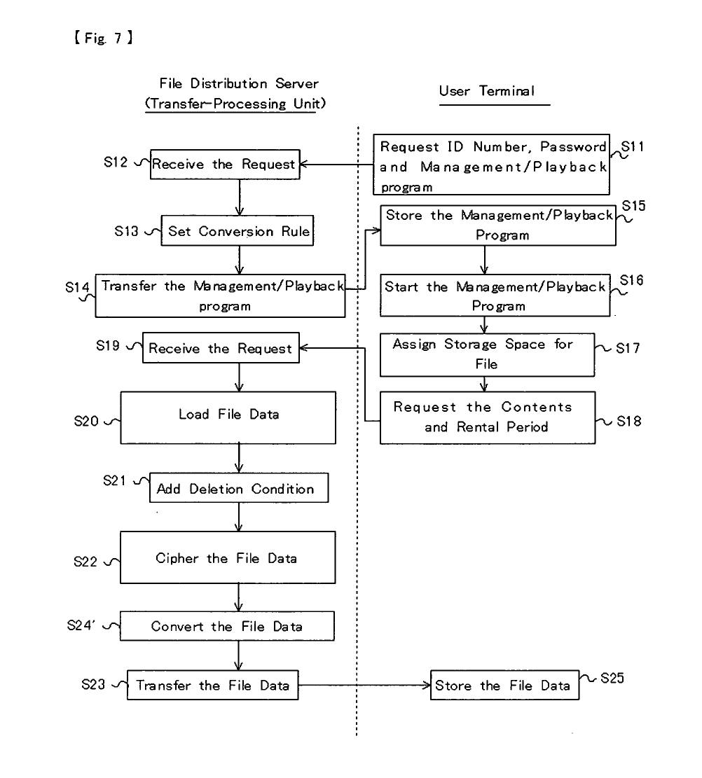

Although so far an example of implementation for the present invention is explained, specific ways of implementation that the present invention can carry out are not limited to the above description. For example, in the above description, the management program that is run on user terminal 4 divides and spreads (converts) the distributed digital file, and stores it in the memory of user terminal 4. The implementation of the present invention, however, is not limited to the structure described above. As shown in FIG. 7, the divide-and-spread process (contents data conversion) can be done in the transfer-processing unit 26 (step 24′). The procedure of the divide-and-spread process can be the same one as described above.

Although deletion condition data in the original explanation is divided-and-spread as well as digital file data, it is possible to convert only digital file data.

In addition, the conversion rule unique to each user is not limited to the formula shown above. For example, one with a random number is also effective.

Furthermore, it is although the example which distributes and stores both sides of a file data playback program and file data in each user terminal, distribution storing only of the file data playback program may be carried out, and the very thing may distribute only file data using storage media, such as a floppy disk or CD-ROM.

On the other hand, the file data itself is distributed, and when performing the so-called streaming distribution which performs playback in real time, the above-mentioned purpose can be attained by being with what has the distribution management module which manages the file data which transmits as a server for distribution according to the playback demand from a user terminal, and a playback stop demand for every user terminal.

Since a user terminal should have only the function which plays back the file data only distributed when such a file data distribution server is used, even if it uses a general-purpose file playback program, it becomes possible to ensure playback control.

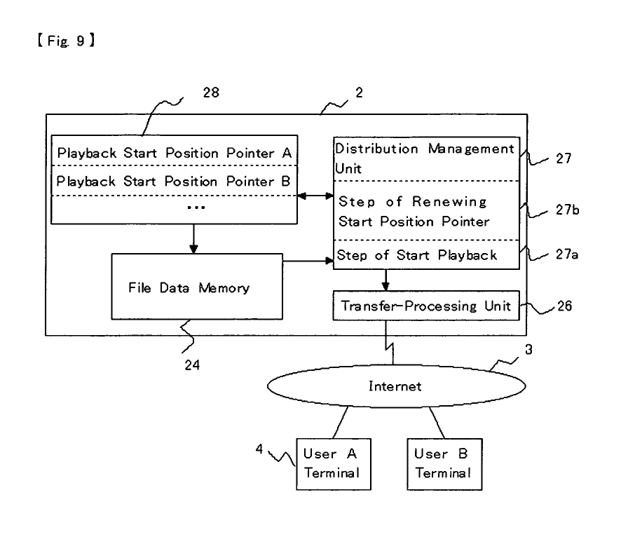

FIG. 9 is a block diagram showing the general structure of the above-mentioned file distribution server. In addition to the above-mentioned composition, this file distribution server 2 has the distribution module 27 and the playback start position pointer 28.

The distribution management module 27 has the function which the playback stop means had in the above-mentioned file playback program, and it has processing 27a which starts a playback from the position which the playback start position pointer 28 formed for every user terminal shows, and processing 27b updates the above-mentioned playback start position pointer in a playback stop position.

That is, playback start processing 27a is processing which acquires the position information which the playback start position pointer 28 formed for every user terminal shows, reads the file data of this position from the file data memory module 24, and outputs this to the transmitting processing module 26 continuously. In this way, if a stop instruction is received from user-terminal equipment 4, the processing which updates the corresponding playback start position pointer 28 of a user terminal in the position concerned will be made by resetting of pointer 27b.

Moreover, the distribution management module 27 may have the processing which updates a corresponding playback start position pointer by receiving the pointer change demand of the fast forward and rewinding from user-terminal equipment 4. In this case, after satisfying the prescribed playback conditions that, explained in the above-mentioned file data playback program, it is desirable to give the function to suspend updating processing of rewinding of the playback position pointer.

Therefore, the file data playback program can play back files continually even if playback and stop are carried out repeatedly on one hand, files once played back are not played back again any more because playback start position pointer is reset at the position where playback is stopped by means to stop playing back on the other. Therefore, if it is used for playback of files for which payment is required that are frequently played back and stopped repeatedly, it becomes possible to restrict playback without damaging the files.

1. A file data playback program which includes:
means to playback a file;
means to stop playback of a file;
wherein said means to play back file data are means to start playback from the position indicated by a playback start position pointer, and said means to stop playing back file data are means to carry out a step of stopping playback, and a step of resetting said playback start position pointer at the playback stop position, wherein said playback start position pointer is reset with said means to stop playing back file data.

2. The file data playback program according to claim I wherein said playback start position pointer is updated by said playback stop position means or the pointer control means, and said pointer control means is a means to suspend the updating function of said playback start position pointer, after fulfilling prescribed playback conditions.

3. The file data playback program according to claim 1 or 2 further including means to delete said file data which ended a playback.

4. The file data playback program according to claim 1 or 2 wherein the playback stop means includes processing that deletes the file data which completed the playback.

5. The memory medium wherein the file playback program which stores the program described in claim 1 or 2 is stored.

6. A server for program distribution connected to a user terminal through a communication network, and the distribution server for the file playback program which distributes programs described in claim 1 or 2.

7. The file data distribution system which comprises the program distribution server described in claim 6, the file distribution server and user terminal.

8. A server for file data distribution connected to a user terminal through a communication network comprising:
a file data memory having digital file data to be transmitted, the distribution management unit which manages the file data which is transferred according to the playback demand from said user-terminal, and a playback stop demand for every user terminal and the transfer-processing unit which transfers the file data stored in said file data memory according to the distribution command of a distribution management unit,
wherein said distribution management unit performs a step of a step which starts a playback from the position which a playback start position pointer shows and a step which updates said playback start position pointer in a playback stop position.

9. The file distribution server according to claim 8,
wherein said distribution management unit has a step which updates a playback start position pointer by the pointer change demand from a user terminal and after fulfilling prescribed playback conditions, updating processing of the playback position pointer by the pointer change demand of user-terminal is suspended.
